(19) United States
(12) Patent Application Publication
(10) Pub. No.: US 2018/0056427 A1
(43) Pub. Date: Mar. 1, 2018

(54) INVERTER DIGITAL CONTROL

(71) Applicant: ESAB AB, Gotenburg (SE)

(72) Inventor: Tomas Forslund, Alafors (SE)

(21) Appl. No.: 15/684,121

(22) Filed: Aug. 23, 2017

Related U.S. Application Data
(60) Provisional application No. 62/382,040, filed on Aug. 31, 2016.

(51) Int. Cl. B23K 9/10; B23K 9/095

(52) U.S. Cl. CPC B23K 9/1062; B23K 9/0956

(57) ABSTRACT

Various embodiments may be generally directed to providing synchronized digital control of a welding power supply. Synchronization can be based on inverter gate pulses of the welding power supply. By basing synchronization on the inverter gate pulses, sampling operations, data collection operations, data processing operations, and other control functions can take place at advantageous times. In particular, these system operations can occur at times other than the switch-on times of the inverter, thereby improving the reliability and integrity of the synchronized system operations.

### CROSS-REFERENCE TO RELATED APPLICATIONS

This application claims the benefit of U.S. Provisional Patent Application No. 62/382,040, filed on Aug. 31, 2016, the disclosure of which is incorporated by reference herein in its entirety.

### TECHNICAL FIELD

The present embodiments are related to power supplies for welding type power, that is, power generally used for welding, cutting, or heating.

### BACKGROUND

In many conventional welding power supplies, data is shared between different constituent components of the power supply. However, the data may not be shared in a synchronized manner. Further, operational events may occur at disadvantageous times. For example, sampling events for collecting data on actual output currents may occur during switch-on events for the output inverter, thereby disturbing the integrity and reliability of the sampled data. Consequently, efficient control of the power supply may be compromised.

It is with respect to these and other considerations that the present disclosure is provided.

### SUMMARY OF THE INVENTION

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

Various embodiments may be generally directed to providing synchronized digital control of a welding power supply. Synchronization can be based on inverter gate pulses of the welding power supply. By basing synchronization on the inverter gate pulses, sampling operations, data collection operations, data processing operations, and other control functions can take place at advantageous times. In particular, these system operations can occur at times other than the switch-on times of the inverter, thereby improving the reliability and integrity of the synchronized system operations.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### DESCRIPTION OF FIGURES

FIG. 1 illustrates a conventional welding power source.

FIG. 2 illustrates techniques for synchronizing control and operation of a welding power source based on operation of an inverter of the welding power source.

FIG. 3 illustrates a welding system that can implement the synchronization techniques depicted in FIG. 2.

### DESCRIPTION OF EMBODIMENTS

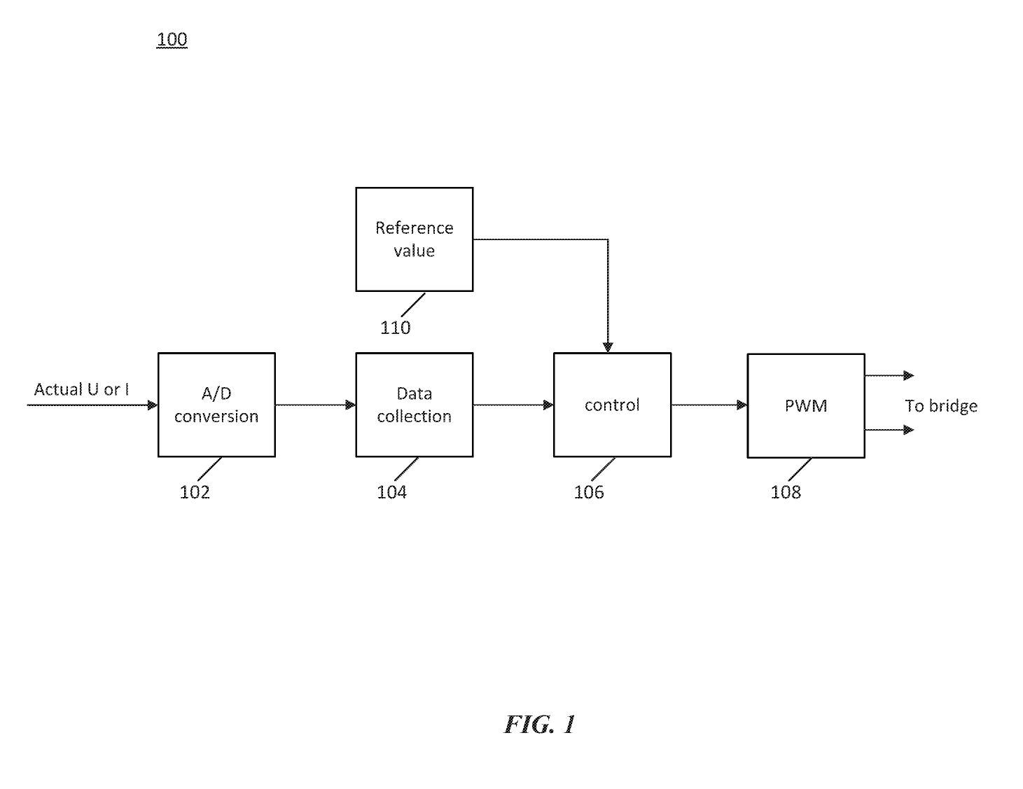

FIG. 1 illustrates a conventional welding power source 100. The conventional welding power source 100 can include an analog-to-digital (A/D) conversion module 102, a data collection module 104, a control module 106, a pulse width modulator (PWM) module 108, and a reference value module 110.

The A/D conversion module 102 can receive actual voltage or current information. The A/D conversion module 102 can receive from one or more sensors information indicative of an output voltage or current of the conventional welding power source 100. The A/D conversion module 102 can receive analog information regarding an output current or voltage and can convert the analog information to digital information. Digital information generated by the A/D conversion module 102 can be provided to the data collection module 104.

The data collection module 104 can collect information from the A/D conversion module 102. The data collection module 102 can accumulate information regarding the actual output current or voltage of the conventional welding power source 100. The data collection module 104 can further process the accumulated information regarding the output of the conventional welding power source 100. For example, the data collection module 104 can filter accumulated data or can generate predictive data based on any received data. The data collection module 104 can provide information regarding the output current or voltage of the conventional welding power source 100 to the control module 106.

The control module 106 can control operation of the conventional welding power source 100. Specifically, the control module 106 can control operation of the PWM module 108. For example, the control module 106 can control operation of the PWM module 108 such that the PWM module 108 provides a desired output signal (e.g., a desired output current or voltage). The control module 106 can provide control information to the PWM module 108 to control operation and output of the PWM module 108.

The control module 106 can generate control information for the PWM module 108 based on information provided by the data collection module 104. The control module 106 can also generate the control information for the PWM module 108 based on reference information provided by the reference value module 110. The reference value module 110 can calculate and/or store reference information related to an output of the conventional welding power source 100. For example, the reference value module 110 can provide a reference output current value or a reference output voltage value to the control module 106.

The control module 106 can subsequently compare the reference information from the reference value module 110 to the information provided by the data collection module 104, which can be indicative of a current or actual output of the conventional welding power source 100 while the reference information can be indicated of a desired output of the conventional welding power source 100. Based on the comparison, the control module 106 can adjust operation of the PWM module 108 to drive an output of the conventional welding power source 100 towards a desired reference value. In this way, control information is provided to the PWM module 108 from the control module 106 that can be based on a comparison of actual/current and desired/reference output values.

The PWM module 108 can receive control information from the control module 106. The control information can control operation of the PWM module 108 such that an output of the conventional welding power source 100 can be adjusted. The PWM module 108 can generate signals for controlling downstream components of the welding power source 100 (not shown in FIG. 1 for simplicity) to effectuate changes to the output current and/or voltage of the conventional welding power source 100. These downstream components can include, for example, two halves of a full bridge output inverter. The downstream components coupled to the PWM module 108 which provide the output current and/or voltage can include one or more sensors for detecting actual output voltage and/or current. This collected sensor information can then be provided to the A/D conversion module 102 as described above.

Each of the components shown in FIG. 1 can receive and/or pass data or information to one or more other components of the conventional welding power source 100. In many conventional systems, the operations of the components are not synchronized. For example, passing and receiving information between components may not be coordinated. Lack of synchronization and/or coordination can cause operational events of the components to occur at disadvantageous times. In particular, operational events may occur at a time when output signals from the PWM module 108 to the output inverter are generated and/or transmitted, which can disturb the integrity of the operational events of the components. For example, sampling events (e.g., by the A/D conversion module 102) or data handling or processing events (e.g., by the data collection module 104) may occur during a switch-on event of the inverter as controlled by the PWM module 108, which can result in the generation of noisy and therefore less useful samples.

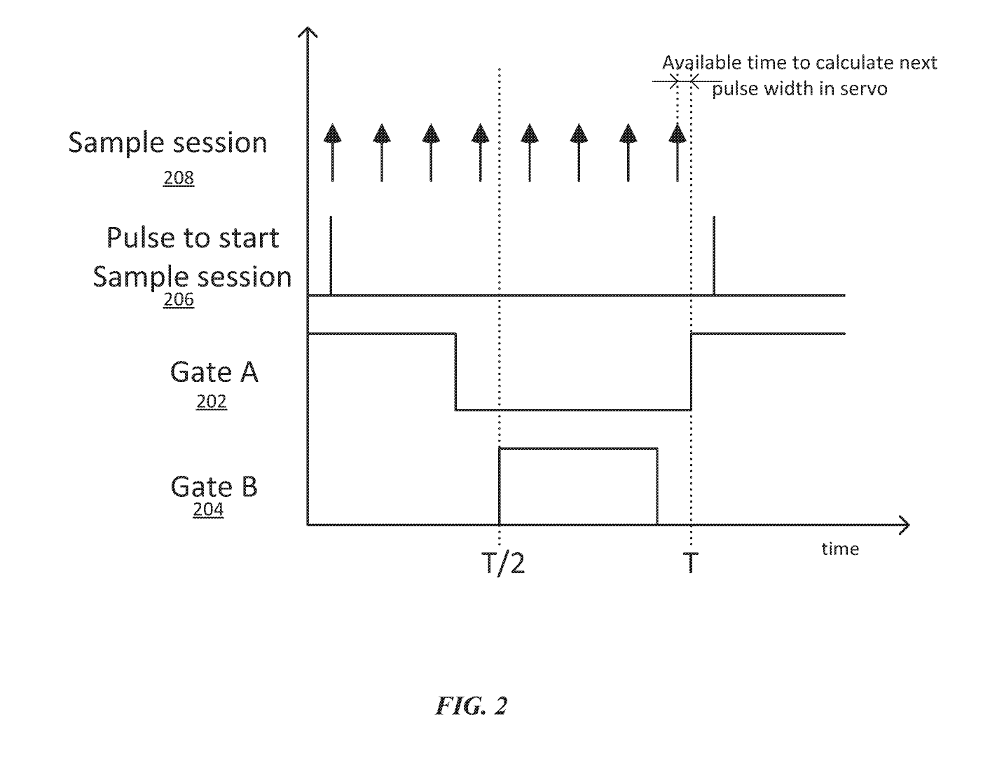

FIG. 2 illustrates synchronization of a welding power source according to techniques described herein. In particular, FIG. 2 shows techniques for synchronizing control and operation of a welding power source based on operation of the inverter—for example, gate pulse signals used to operate the inverter as provided or generated by an inverter controller (e.g., a PWM module). Synchronization based on inverter control signals (e.g., gate pulse signals) can enable data sampling events to be timed so as not to occur during switch-on events of the inverter, thereby preserving the integrity of the samples. Further, synchronization based on inverter control signals can enable the reliable coordination of events throughout a welding power supply. For example, synchronization based on inverter control signals can facilitate the timing of when certain events may occur—e.g., data transmission or receipt between components of a welding power supply—to facilitate coordination between components while reducing data latency.

In FIG. 2, a first gate signal 202 (e.g., gate signal A) and a second gate signal 204 (e.g., gate signal B) are shown. The first and second gate signals 202 and 204 can represent gate signals provided to an output inverter (e.g., to the two halves of a full bridge inverter). As shown in FIG. 2, the first and second gate signals 202 and 204 are offset from one another. An inverter period is indicated to comprise a time T as indicated in FIG. 2.

According to the synchronization techniques described herein, operation of a welding power supply can be based on the first and second gate signals 202 and 204. In particular, subsequent to the first gate signal 202 activating (e.g., going high or transitioning to a logic high or “1” level), a start pulse 206 can be generated. The start pulse 206 can be triggered or based off of the first and second gate signals 202 and 204 such that the start pulse 206 occurs after activation of the first gate signal 202 within the inverter period T. Further, the start pulse 206 can occur before the activation of the second gate signal 204. The start pulse 206 can also be periodic as indicated by the second start pulse 206 after a second activation of the first gate signal 202 as shown in FIG. 2.

The start pulse 206 can trigger or initiate a sample session 208. The sample session 208 can comprise multiple sample points or times as shown in FIG. 2. That is, the sample session 208 can trigger or initiate a number of samples being taken at regular time intervals during the inverter period T. In various embodiments, the timing or intervals between the sampling points and the number of sampling points can be varied. The number of sampling points can be set to a fixed value (e.g., 16) or can be adjusted or varied (e.g., for any inverter time period T). Further, the time between each sampling point can be fixed or adjusted (e.g., across or within any inverter time period T). The time interval between each sampling point can be the same or different and can be adjusted such that a sampling point does not occur during activation of the first or second gate pulse 202 or 204 (e.g., during a switch-on event of the inverter). In this way, sampling can occur without any disturbances or with low noise, thereby improving the integrity and reliability of a sampling point.

Operations of a welding power source can be based off of the start pulses 206. For example, operations for data transmission or reception can be triggered off of the start pulses 206 to ensure coordination and low data latency between components of the welding power source. As described above, a sample session 208 comprising multiple sample points can occur during each inverter period T. These sample points can specify when samples of the actual output of the welding power source (e.g., an output current or voltage) can be taken and/or processed. For each inverter period T, the sampled and processed information from the sample session can be provided to a controller. The controller can use the recently collected sample information to adjust operation of the welding power source (e.g., by adjusting operation of an inverter of the welding power source).

Sampled data collected over one or more inverter periods T (e.g., over “n” inverter periods T) can be used to generate new reference information. For example, data collected over n inverter time periods T can be provided to a reference module for calculation of new or updated reference information (e.g., a new or updated reference current or voltage value).

The synchronization techniques illustrated in FIG. 2 can be implemented in software, hardware, or any combination thereof. In various embodiments, the synchronization techniques illustrated in FIG. 2 can be implemented within a welding apparatus using configurable logic. The configurable logic can include, for example, a complex programmable logic device (CPLD), a field-programmable gate array (FPGA), or an application-specific integrated circuit (ASIC). In various embodiments, the inverter control functionality (e.g., the PWM functionality) of a welding apparatus which generates the gate pulses for the inverter as well as the data collection functionality of the welding apparatus can both be implemented within the same control logic. In doing so, exact timing information related to when gate pulses are initiated can be known such that coordination (e.g., generation of the start pulses 206 to trigger a sampling session 208) can be implemented efficiently and with high accuracy and reliability.

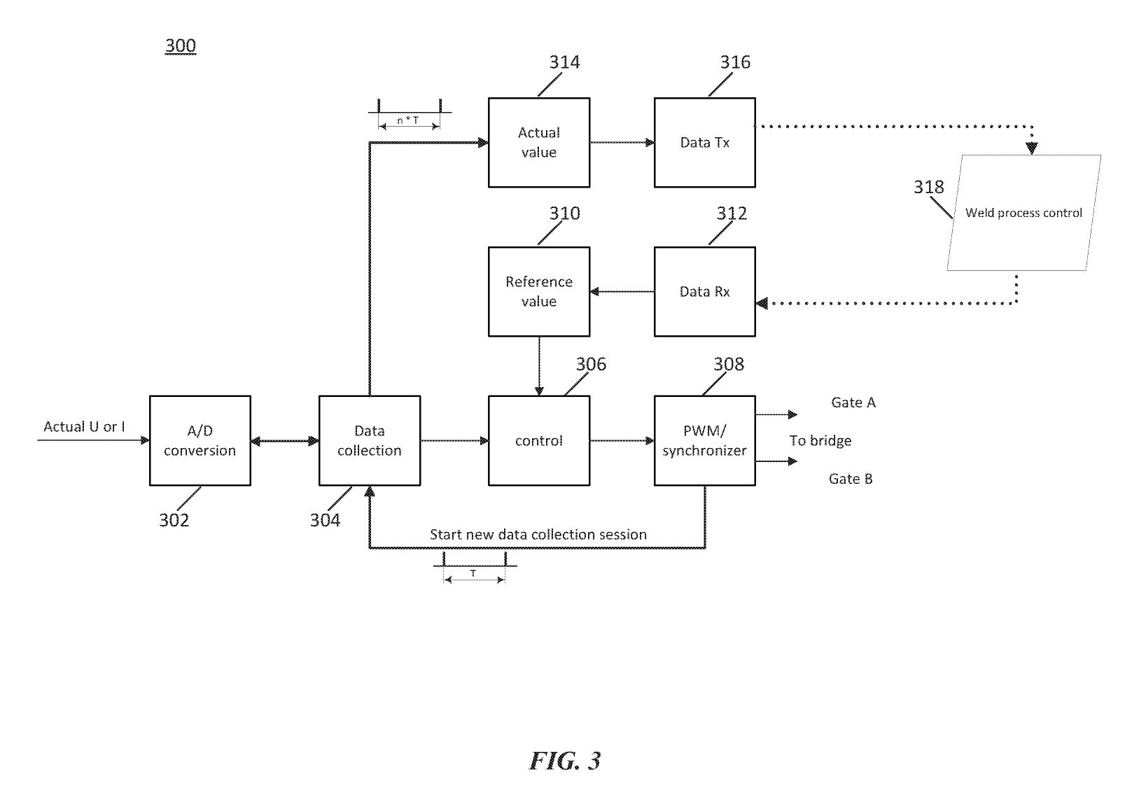

FIG. 3 illustrates a welding system 300 that can implement the synchronization techniques described herein. The welding system 300 can represent a portion of a synchronized digital control system for a welding apparatus.

As shown in FIG. 3, the welding system 300 can include an A/D conversion module 302, a data collection module 304, a control module 306, a PWM and synchronizer module 308, a reference value module 310, a data receiver module 312, an actual value module 314, a data transmitter module 316, and a welding process control (WPC) module 318.

The A/D conversion module 302 can receive actual output current or voltage information. The A/D conversion module 302 can provide digitized information related to the actual output current or voltage to the data collection module 304. The data collection module 304 can accumulate information indicative of the actual output current or voltage and can provide such information to the control module 306. The control module 306 can generate control signals for adjusting operation of the PWM and synchronizer module 308. Specifically, the control module 306 can adjust operation of the PWM and synchronizer module 308 to control the output current or voltage of the welding system 300. In various embodiments, there may be a peak-current-control circuit positioned between the control module 306 and the PWM and synchronizer module 308 (not shown for simplicity in FIG. 3).

The PWM and synchronizer module 308 can be a joint or dual module that provides PWM functionality and synchronization functionality. The PWM functionality can include generation of gate signals for driving an output inverter (not shown in FIG. 3 for simplicity). As shown in FIG. 3, an output of the PWM-synchronizer 308 can include a first gate signal A and a second gate signal B that can control operation of a half bridge output inverter (e.g., the first and second gate signals 202 and 204 depicted in FIG. 2). The PWM-synchronizer 308 can generate the first and second gate signals based on control information provided by the control module 306.

The synchronization functionality can include monitoring operation of the output inverter (e.g., monitoring of gate signal pulses or switch-on events) and can include generation of signals to initiate other operational events within the welding system 300. The synchronization functionality can include those functions, features, and techniques described in relation to FIG. 2. In particular, the PWM-synchronizer module 308 can monitor and determine exactly when a gate pulse for the output inverter is generated/transmitted. The PWM-synchronizer module 308 can then initiate coordinated and synchronized actions in the welding system 300 based on this monitoring.

The PWM-synchronizer module 308 can generate a signal to initiate subsequent actions. As an example, the PWM-synchronizer module 308 can generate the start pulses 206 as described in relation to FIG. 2. The start pulse 206 generated by the PWM-synchronizer module 308 can be provided to the data collection module 304 to trigger or initiate a sampling session 208 as described in relation to FIG. 2. Based on receipt of a signal from the PWM-synchronizer module 308, the data collection module 304 can begin sampling and processing data indicative of actual output current or voltage values which can then be provided to the control module 306 to adjust operation of the output inverter (via the PWM-synchronizer module 308).

Any synchronization signal generated or provided by the PWM-synchronizer module 308 can be used to coordinate operation of other components of the welding system 300. As an example, based on a synchronization signal from the PWM-synchronizer module 308, the data collection module 304 can provide the data collected during one or more sample sessions (indicated in FIG. 3 as “n” sample sessions each of inverter period T) to the actual value module 314. The actual value module 314 can receive collected data from the data collection module 304. The actual value module 314 can process the received data and can provide it to a data transmitter module 316.

The data transmitter module 316 can transmit any data received from the actual value module 314 to the WPC module 318. The WPC module 318 can be located remote from the other components of the welding system 300 depicted in FIG. 3. The data transmitter module 316 and WPC can communicate over any known wireless and/or wired standard or protocol to enable local welding information to be provided to the remotely located WPC module 318.

The WPC module 318 can adjust a welding process based on information received from the data transmitter module 316. Various adjustments to the welding process or operation of the welding system 300 can be determined by the WPC module 318. As an example, the WPC module 318 can generate a new reference value for governing operation of the welding system 300. That is, the WPC module 318 can calculate a new reference current or voltage value for the welding system 300 to be used by the control module 306 for managing operation of the welding system 300 (i.e., the output of the welding system). The new or updated reference value generated by the WPC module 318 can be based on the data collected and processed over n inverter periods T as indicated in FIG. 3. The new or updated reference value generated by the WPC module 318 can then be provided to the data receiver module 312. Alternatively, or in addition thereto, adjustments to a welding process by the WPC module 318 can affect calculation of any reference values calculated by other components of the welding system. That is, operational adjustments made by the WPC module 318 may be used to adjust a reference value and the WPC module 318 itself may not calculate the reference value.

As with the data transmitter module 316, the data receiver module 312 can communicate with the WPC module 318 over any known wireless and/or wired standard or protocol. The data receiver module 312 can pass along any received information (e.g., a new or updated reference current or voltage value or any welding process adjustments) from the WPC module 318 to the reference value module 310. The reference value module 310 can receive a pre-calculated reference value from the WPC module 318 and/or can use information (e.g., welding process information) from the WPC module 318 to calculate a new reference value locally. Under either scenario, the reference value module 310 can provide any new or update reference value to the control module 306. As described above, the control module 306 can adjust operation of the PWM-synchronizer module 308 based on a comparison of approximately instantaneous output information (e.g., from the data collection module 304) and reference value information (e.g., from the reference value module 310).

The PWM-synchronizer module 308 can generate the first and second gate signals 202 and 204 depicted in FIG. 2. The first and second gate signals 202 and 204 can be generated based on control information the PWM-synchronizer module 308 receives from the control module 306. The PWM-synchronizer module 308 can further generate the start pulses 206 depicted in FIG. 2 (or any other synchronization signal). The start pulses 206 can be initiated or triggered based on the first and second gate signals 202 and 204.

As described above, in various embodiments, the inverter control functionality (e.g., the PWM functionality) and the synchronization functionality (e.g., the data collection functionality) of the welding system 300 can both be implemented within the same control logic as represented by the PWM-synchronizer module 308. Further, the number or spacing of the sampling points in the sample session 208 can be determined by the PWM-synchronizer module 308 and/or the data collection module 304. As such, any spacing between the sample points shown in FIG. 2 can be varied in view of the gate pulses 202 and 204 and the inverter period T. Each component depicted in FIG. 3 can be implemented in hardware, software, or any combination thereof.

Operations which occur within an inverter period T (e.g., every inverter period T) can be considered to be operations within the “fast” portion of the control of the welding system 300. For example, the generation of a synchronization pulse by the PWM-synchronizer module 308, the initiation of a new data collection session by the data collection module 304 as triggered by a synchronization signal provided by the PWM-synchronizer module 308, and the use of collected data by the control module 306 on a per inverter period T basis can be considered part of the fast loop or fast control shown in FIG. 3.

In contrast, “slow” loop control or slow control processes can occur over multiple inverter periods T. For example, the collection and processing of data values collected over n inverter time periods T that are provided to the WPC module 318 and calculation of any new reference values by the WPC module 318 and/or the reference value module 310 can be considered to be portions of the slow loop or slow control of the welding system 300. Each of these control processes can be based on the inverter gate pulses according to the synchronization techniques described herein. The fast loop control can be considered to be the servo control for the welding system 300. The slow loop control can be considered to the weld process control of the welding system 300.

By synchronizing the control system depicted in FIG. 3 to the inverter gate pulses, sampling can be avoided during disadvantageous times. Further, latency within the control system of the welding system 300 can be minimized or reduced compared to conventional systems. Additionally, synchronization can be implemented with an accuracy of one clock cycle for sampling.

By employing configurable logic (e.g., an FPGA, CPLD, or ASIC) for the fast part of the control for the welding system 300, information regarding the gate pulses for driving the inverter can be easily accessed. Further, since the PWM functionality which generates the gate pulses and the data collection functionality can both be implemented in the same logic, the exact time a gate pulse is initiated can be known. In turn, the gate pulses can be used to synchronize control of the welding system, can be used to specify exactly when to take samples, and can be used to specify when to start a new calculation in the slower control loop. This enables the welding system 300 to avoid sampling too close to a switch-on event (which can cause noisy samples) and also allows the weld process control calculations to be started immediately after fresh data has been collected. This is illustrated in FIGS. 2 and 3 together, where a synchronizing pulse 206 can invoke data collection (see sample session 208) and fresh collected data can be sent to the fast control immediately after every sampling session 208 and to weld process control immediately after n sample sessions have been collected and filtered in an appropriate way.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Furthermore, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Thus, the claims set forth below should be construed in view of the full breadth and spirit of the present disclosure as described herein.

What is claimed is:

1. A welding power supply, comprising:
a pulse width modulator (PWM)-synchronizer module, to generate gate pulses for an output inverter and to generate a synchronization signal based on the gate pulses;
a data collection module, to sample an output of the power supply based on the synchronization signal; and
a control module to control operation of the PWM-synchronizer module based on data provided by the data collection module and reference data.

2. The welding power supply of claim 1, wherein the synchronization signal is generated after a switch-on event of the output inverter as triggered by a gate pulse.

3. The welding power supply of claim 2, wherein the synchronization signal triggers a sample session.

4. The welding power supply of claim 3, wherein the sample session is implemented by the data collection module.

5. The welding power supply of claim 4, wherein the sample session comprises multiple sampling points.

6. The welding power supply of claim 5, wherein the sample session occurs during an output inverter time period T as determined by successive gate pulses.

7. The welding power supply of claim 6, wherein the multiple sampling points occur after and prior to a switch-on event of the output inverter.

8. The welding power supply of claim 6, wherein the data collection module samples the output of the power supply during each output inverter time period T.

9. The welding power supply of claim 6, wherein the reference data is updated after one or more output inverter time periods T.

10. The welding power supply of claim 1, wherein the output of the power supply is adjusted based on control information provided to the PWM-synchronizer module by the control module.

11. The welding power supply of claim 1, wherein the PWM-synchronizer is implemented within the same logic module.

12. A method, comprising:
generating gate pulses for an output inverter of a welding power supply using a pulse width modulator (PWM)-synchronizer module;
generating a synchronization signal based on the gate pulses using the PWM-synchronizer module;
sampling an output of the welding power supply based on the synchronization signal using a data collection module; and
controlling operation of the PWM-synchronizer module based on data provided by the data collection module and reference data.

13. The method of claim 12, wherein the synchronization signal is generated after a switch-on event of the output inverter as triggered by a gate pulse.

14. The method of claim 13, wherein the synchronization signal triggers a sample session.

15. The method of claim 14, wherein the sample session is implemented by the data collection module.

16. The method of claim 15, wherein the sample session comprises multiple sampling points.

17. The method of claim 16, wherein the sample session occurs during an output inverter time period T as determined by successive gate pulses.

18. The method of claim 17, wherein the multiple sampling points occur after and prior to a switch-on event of the output inverter.

19. The method of claim 17, wherein the data collection module samples the output of the power supply during each output inverter time period T.

20. The method of claim 17, further comprising updating the reference data after one or more output inverter time periods T.
